(19) United States
(12) Patent Application Publication
(10) Pub. No.: US 2024/0149299 A1
(43) Pub. Date: May 9, 2024

(54) APPARATUS AND METHOD FOR INLINE CONTINUOUS-FLOW LIVERY APPLICATION

(71) Applicant: The Boeing Company, Chicago, IL (US)

(72) Inventors: Shane Arthur, Kirkland, WA (US); Kjersta Larson-Smith, Seattle, WA (US); Ryan E. Piper, Summerville, SC (US)

(21) Appl. No.: 17/983,162

(22) Filed: Nov. 8, 2022

(51) Int. Cl. B05D 7/00; B41J 2/045; B41J 3/413; B41M 5/00; B41M 7/00

(52) U.S. Cl. CPC B05D 7/576; B41J 2/04586; B41J 3/413; B41M 5/0011; B41M 7/0027

(57) ABSTRACT

Disclosed herein is a surface preparation and livery printing system and a method of preparing a surface and printing a livery. The method includes preparing a surface of an aircraft part in a first processing booth to form a prepared surface of the aircraft part. The method also includes transporting the aircraft part to a second processing booth being adjacent to the first processing booth upon completion of preparing the surface. The method further includes applying a livery to the prepared surface of the aircraft part in a second processing booth and upon completion of applying the livery, transporting the aircraft part to a third processing booth being adjacent to the second processing booth. The method still further includes applying a clearcoat over at least the livery applied to the prepared surface of the aircraft part in a third processing booth.

### FIELD

This disclosure relates generally to preparing and printing on complex aircraft parts, and more particularly to improving efficiencies in preparation and printing processes.

### BACKGROUND

Treating and printing livery onto aircraft surfaces, to ensure proper adherence of applied materials to the aircraft surfaces, is difficult. Moreover, conventional methods for treating and printing livery onto aircraft surfaces is inefficient.

### SUMMARY

The subject matter of the present application has been developed in response to the present state of the art, and in particular, in response to the shortcomings of conventional large surface area printing, including printing on curved or contoured surfaces, that have not yet been fully solved by currently available techniques. Accordingly, the subject matter of the present application has been developed to provide methods and systems that overcome at least some of the above-discussed shortcomings of prior art techniques.

The following is a non-exhaustive list of examples, which may or may not be claimed, of the subject matter, disclosed herein.

In one example, a method includes preparing a surface of an aircraft part in a first processing booth to form a prepared surface of the aircraft part. The method also includes transporting the aircraft part to a second processing booth being adjacent to the first processing booth upon completion of preparing the surface. The method further includes applying a livery to the prepared surface of the aircraft part in a second processing booth and upon completion of applying the livery, transporting the aircraft part to a third processing booth being adjacent to the second processing booth. The method still further includes applying a clearcoat over at least the livery applied to the prepared surface of the aircraft part in a third processing booth.

In another example, a system includes a first processing booth configured to enable preparation of a surface of an aircraft part, a second processing booth configured to enable application of a livery to at least a portion of the surface of the aircraft part, and a first common partition disposed between the second processing booth and the first processing booth. The system further includes a third processing booth configured to enable application of a clearcoat over at least a portion of the surface of the aircraft part and a second common partition disposed between the second processing booth and the third processing booth.

In still another example, a hangar bay includes a surface processing structure having a first processing booth configured to enable preparation of a surface of an aircraft part, a second processing booth configured to enable application of a livery to at least a portion of the surface of the aircraft part, and a first common partition disposed between the second processing booth and the first processing booth. The surface processing structure further includes a third processing booth configured to enable application of a clearcoat over at least a portion of the surface of the aircraft part and a second common partition disposed between the second processing booth and the third processing booth.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which

FIG. 1 is a perspective view of a surface preparation, printing, and finishing environment, according to one or more examples of the present disclosure;

FIG. 2 is a schematic flow diagram of a method performed in the environment of FIG. 1, according to one or more examples of the present disclosure;

FIG. 3 show a schematic flow diagram of a method of each processing step of FIG. 2, according to one or more examples of the present disclosure;

FIG. 4 is a perspective view of a paint/image removal, surface preparation, printing, and finishing environment, according to one or more examples of the present disclosure; and

FIG. 5 is a schematic flow diagram of a method performed in the environment of FIG. 4, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Reference is made to herein to the term “printed” or “inkjet printed” or “ink-jet printed” or “ink jet printed” to mean a method of forming a printed surface using ink as the print medium. The ink may be solid or liquid or the like ink. The term “painted” or “painting” refers to the process of using paint in the application method.

The following detailed description is intended to provide both apparatuses, systems, and methods for carrying out the disclosure. Actual scope of the disclosure is defined by the appended claims.

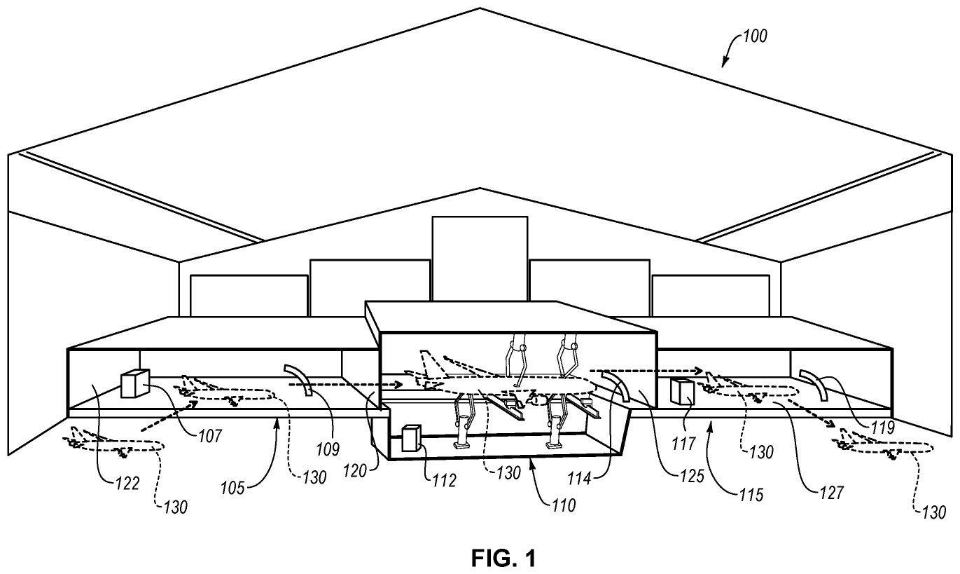

Referring to FIG. 1, a hangar bay 100 includes multiple surface treatment bays adjacent each other and each being independently environmentally controlled. In various embodiments, the surface treatment bays include a surface preparation bay 105, a livery application bay 110, and a surface finishing bay 115. As used herein, unless otherwise indicated, “the bays” means a surface preparation bay 305, a livery application bay 310, and a surface finishing bay 315.

In various embodiments, movement of the aircraft part 130 into and between each of the bays may be performed by various devices, such as an overhead crane system, aircraft tugs, tracked systems, or the like. The aircraft part 130 or the aircraft parts may be moved between adjacent to bays without being exposed to the environment external to the surface treatment bays but still within the hangar bay 100. Because each of the bays are adjacently located with sealable doors or partitions 120, 125 between the bays, respectively, and a sealable entrance partition 122 to the surface preparation bay 105 and sealable exit partition 127 to the surface finishing bay 115, environmental integrity is maintained around the aircraft part 130 from once processing starts at the surface preparation bay 105 to when processing ends at the surface finishing bay 115. In other words, the aircraft part 130 or the aircraft parts may be moved between adjacent bays, without being exposed to the environment external to the surface treatment bays, because the environments within each of the bays are controlled and the partitions 120, 122, 125, 127 are sealable.

In the surface preparation bay 105, the surface of the aircraft part 130 is prepared before any one of a primer, a basecoat, or a monocoat is applied. The aircraft part 130 may be a fully assembled aircraft or a portion of a fully assembled aircraft, such as, without limitation, a fuselage with or without a vertical stabilizer, a fuselage with or without wings, unattached wings, unattached vertical stabilizer, or unattached elevators. A maskant or covering is applied to the surface of the aircraft part 130 to expose only those portions of the surface to be prepared. The exposed portions of the surface may also receive livery in the livery application bay 110. Accordingly, the maskant or covering may stay in place for the entire preparation and printing process if the maskant material is used for overspray protection and does not become compromised during the preparation process. Wheel well coverings are an example where the coverings can be left on for the processes performed in the surface preparation bay 105, the livery application bay 110, and the surface finishing bay 115.

After the maskant is applied onto the surface, particulates are removed from the surface. The surface preparation bay 105 may include an air compressor for applying forced air on the surface to remove particulates from the surface. Additionally or alternatively, the surface preparation bay 105 may include solvents, moist wipes, dry wipes, and/or tack rags that are applied to the surface to remove particulates from the surface. One or more of a primer, basecoat, or monocoat is then applied in accordance with aircraft surface material properties, the spatial characteristics of the livery to be applied to the aircraft surface, and surface protection requirements. The surface preparation bay 105 may include a heating and ventilation air conditioning (“HVAC”) system 107 that maintains humidity, air pressure, air quality, or the like at levels conducive to preparing the surface and applying the primer, basecoat, and/or monocoat. The surface preparation bay 105 may include a heating device 109 if drying of the surface or curing of materials applied to the surface is to be performed. The processes performed in the surface preparation bay 105 may be performed manually. However, robotic devices or mechanically assisted devices may also be used. Any fully robotic devices may be controlled automatically by a controller/processor having a user interface for allowing an operator to control processes.

In the livery application bay 110, a livery is applied to at least a portion of the surface of the aircraft part 130. As used herein, a livery is any of various simple or comprehensive images applied (e.g., printed, painted, adhered) onto an exterior surface of a part. In certain examples, the livery of an aircraft includes a set of insignia comprising color, graphic, and typographical identifiers, which operators apply to their aircraft to identify the operators of the aircraft. The livery application bay 110 includes environmental features that adhere to various predefined requirements that are associated with efficient, effective livery application. For example, the livery application bay 110 may include an HVAC system 112 that maintains humidity, air pressure, air quality, or the like at predefined levels. The livery application bay 110 includes a livery application device, such as, without limitation, an automated robotic inkjet system. The livery application bay 110 may include a heating device 114 if drying of the surface or curing of materials applied to the surface is to be performed. The processes performed in the livery application bay 110 may be performed manually using manual paint application techniques. Also, decorative livery may be applied in the livery application bay 110. A created decal can include the decorative livery. Alternatively or additionally, the decorative livery may applied manually. The partition 120 may be sealable for temporarily keeping the environment of the surface preparation bay 105 separate (e.g., isolated or sealed) from the environment of the livery application bay 110. In certain examples, the hangar bay 100 is configured to process multiple aircraft in different bays at the same time. In such examples, the aircraft part 130 is not moved into the livery application bay 110 until any aircraft part 130 in the in the livery application bay 110 is moved out of the livery application bay 110 and into the surface finishing bay 115.

In the surface finishing bay 115, surface finishing steps are performed, such as, without limitation, touch up and application of a clearcoat. The surface finishing bay 115 may include an HVAC system 117 that maintains humidity, air pressure, air quality, or the like at levels conducive to preparing the surface and applying the clearcoat. The surface finishing bay 115 may include a heating device 119 if drying of the surface or curing of materials applied to the surface is to be performed. The processes performed in the surface finishing bay 115 may be performed manually, however, robotic devices or mechanically assisted devices may also be used. Any fully robotic devices may be controlled automatically by a controller/processor having a user interface for allowing an operator to control processes. The partition 125 may be sealable for temporarily keeping the environment of the livery application bay 110 separate (e.g., isolated or sealed) from the environment of the surface finishing bay 115. After the process performed in the surface preparation bay 105 is complete, the partition 125 is opened and the aircraft part 130 is moved, via the motion device, into the surface finishing bay 115.

The surface preparation bay 105, the livery application bay 110, and/or the surface finishing bay 115 may be sized according to the aircraft part 130, such as a fuselage or wing. In certain examples, the surface preparation bay 105, the livery application bay 110, and the surface finishing bay 115 are limited in size to improve the cost and reduce the complexity of controlling heat/cool, humidity, and air quality. Also, by performing the processes for the aircraft part 130 within multiple adjoining bays, safety is improved because there is less of a need for wing stands and stacker/lifts, thereby reducing collision avoidance incidents.

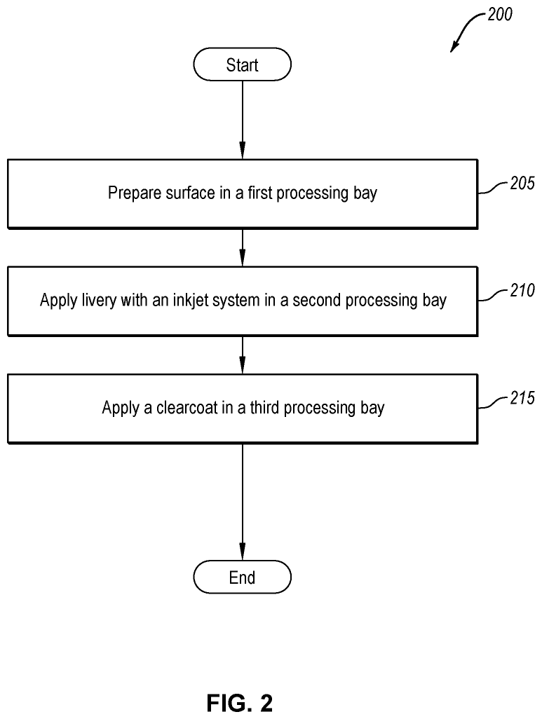

Referring to FIG. 2, according to one example, a method 200 of applying a livery to an aircraft part is shown. The method 200 includes (block 205) preparing a surface of the aircraft part in a first processing bay. Additionally, the method 200 includes (block 210) applying a livery with an inkjet system using ink as the print medium in a second processing bay. Additionally, the method 200 includes (block 215) applying a clearcoat in a third processing bay.

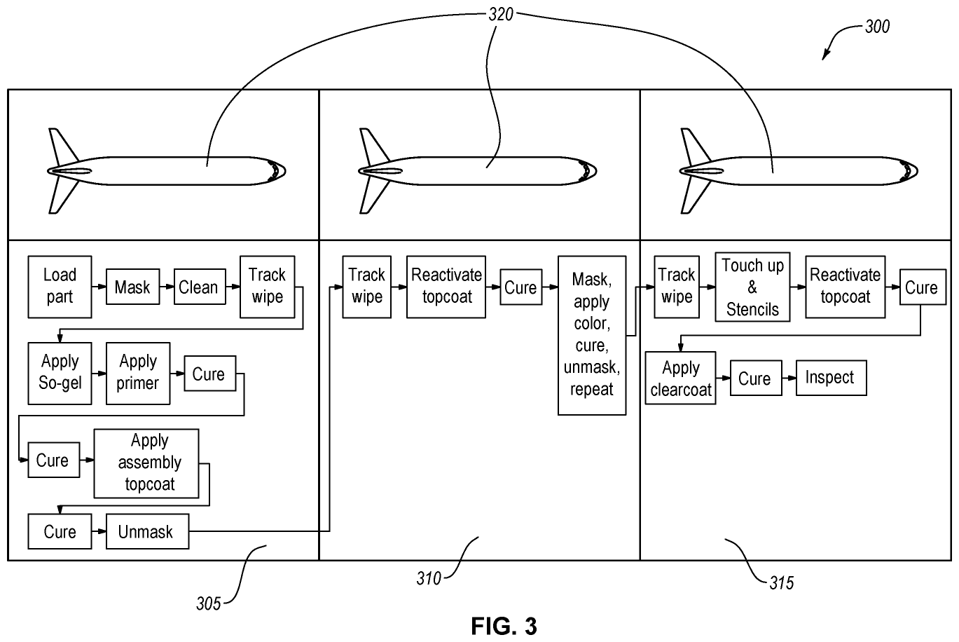

Referring to FIG. 3, in various embodiments, an exemplary in-line surface preparation flow 300 includes a surface preparation stage 305, a livery application stage 310, and a surface finishing stage 315. The surface preparation stage 305 includes loading the part (e.g., a wingless fuselage 320) into the surface preparation bay 105, then masking and cleaning the surface of the wingless fuselage 320 according to a predefined surface preparation plan. Then, the surface of the wingless fuselage 320 is tack wiped followed by applying a corrosion protection material and/or an adhesive promoter (e.g., sol-gel) as appropriate for the surface. A primer is then applied and cured. Another optional intermediate primer coat may be applied followed by a curing step. Then an assembly topcoat is applied and cured followed by removal of the mask.

The livery application stage 310 includes a tack wiping step, followed by reactivating a topcoat (e.g., application of an adhesion promoter (“AP-1”) and/or abrading) and curing. Then the surface is masked, and each of the colors are separately applied and cured according to the livery design. The mask is then removed.

The surface finishing stage 315 includes another tack wiping step, touch up and/or stenciling as necessary, topcoat reactivation as necessary, and curing. A clearcoat is applied as necessary followed by a curing step. After an inspection step, the surface preparation of the fuselage 320 is complete and the fuselage 320 is moved out of the surface finishing bay 115 to another manufacturing stage/location.

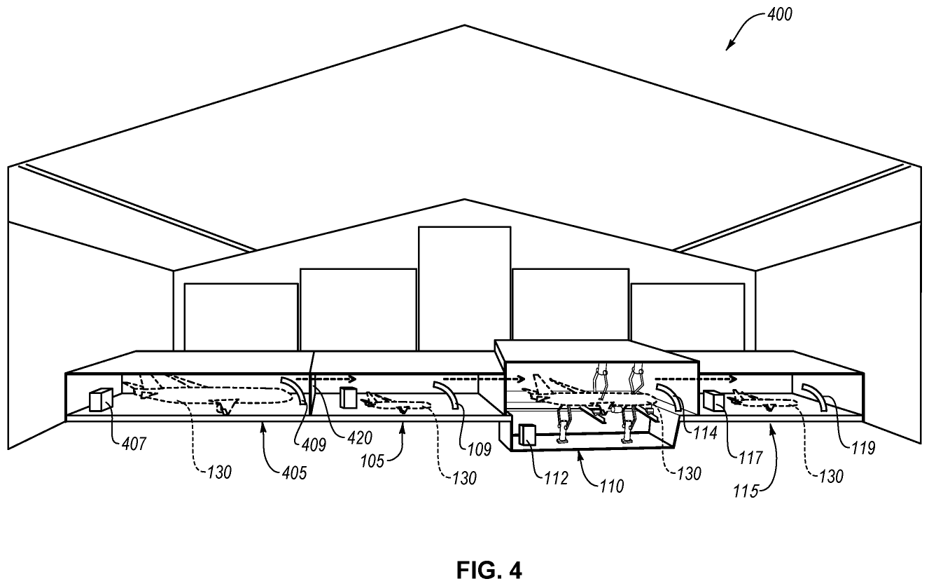

Referring to FIG. 4, a hangar bay 400 includes the surface preparation bay 105, the livery application bay 110, the surface finishing bay 115, and a paint removal bay 405. The paint removal bay 405 and the surface preparation bay 105 are separated by a movable door or partition 420. The partition 420 may be sealable for keeping the environment of the paint removal bay 405 separate from the environment of the surface preparation bay 105. In the paint removal bay 405, any images, decals, surface defects, or the like are removed or fixed by a variety of different processes. The addition of the paint removal bay 405 allow for surface treatment to be applied to at least fleet aircraft.

In various embodiments, the surface preparation bay 105, the livery application bay 110, the surface finishing bay 115, and the paint removal bay 405 include various safety equipment that is applicable to the processes performed in the respective bay. The safety equipment may include fire retardant systems that use fire retardants that are applicable to the materials that might ignite in the respective bays.

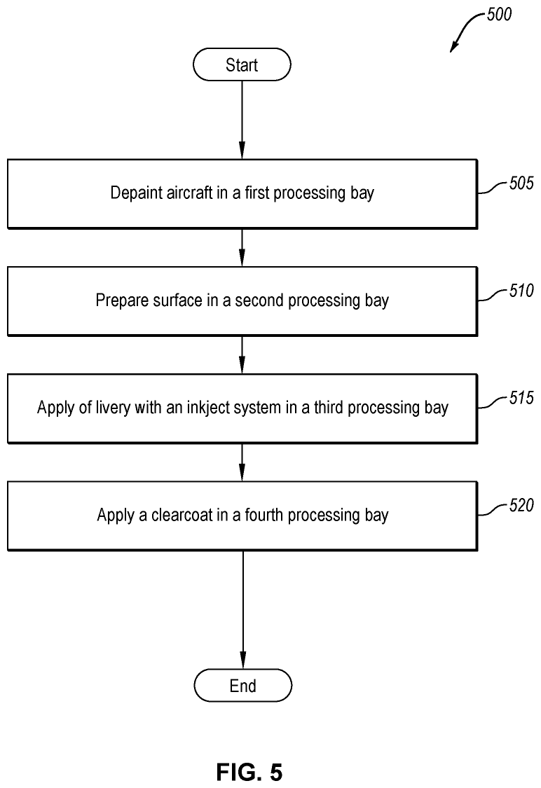

Referring to FIG. 5, according to one example, a method 500 of surface treating a previously painted aircraft or aircraft part includes (block 505) depainting an aircraft or aircraft part in a first processing bay. Additionally, the method 500 includes (block 510) preparing a surface of the aircraft or aircraft part in a second processing bay. Additionally, the method 500 includes (block 515) applying a livery with an inkjet system in a third processing bay. Additionally, the method 500 includes (block 520) applying a clearcoat in a fourth processing bay.

In various embodiments, livery application bay 110 may include a livery-making system that includes an automated robotic printing system. The robotic printing system uses a control path and real-time sensor information to control a robotic printing system for performing livery printing of aircraft parts.

In various embodiments, the livery-making system may include a training system that include a processor, an input/output (“I/O”) device(s), and a memory device. The processor is in data communication with the I/O device(s) and the memory device. The memory device is a computer-readable medium that includes program code instructions (i.e., software) that when executed by the processor performs a number of predefined tasks. The processor receives a three-dimensional (3D) digital model of the aircraft part to be painted. The 3D model may be stored in the memory device or the 3D model may be received from another 3D model generating system. The memory device includes a non-transient computer-readable medium, such as random-access memory (RAM), read-only memory (ROM), or other memory structure.

In various embodiments, the livery-making system receives simulated sensor data or actual sensor data received from sensors. The simulated or actual sensor data includes environmental information, such as humidity, atmospheric pressure, or other environmental data. Additionally, or alternatively, the simulated or actual sensor data includes simulated or actual measurement information.

In various embodiments, the printing system may include a robotic component, a printhead assembly, and/or a memory device. The printhead assembly includes a plurality of printheads, a plurality of actuators, and a plurality of sensors. The printhead assembly is robotically controlled. As used herein, a robotic system can include one or more robotic controllers, actuator arms, motors, wheels, pullies, end effectors, and the like, which in some examples are well known in the art. The robotic controller of the robotic system is programmable to control actuation of the actuatable components of the robotic system.

As discussed above, the robotic controller is programmed to transmit operational commands to the printhead assembly and other actuators/motors for controlling movement of the other actuators/motors and the actuators of the printhead assembly.

In various embodiments, the sensors are configured to scan and collect data during operation of the printing system, including printing operations performed by the robotic controller, the actuators/motors, and the printhead assembly. In some examples, the sensors include vision data sensors, such as a digital camera or other such vision sensors, distance data sensors, such as a time-of-flight camera, a light detection and ranging (“LIDAR”) sensors or other such distance measurement sensors, topography sensors, such as an interferometer, a profilometer or other such surface topography sensors, capacitive transducers, or ultrasound transducers.

In one non-limiting example, the sensors include surface scanning lasers configured to scan and collect surface topography data of the contoured surface of the aircraft part and the surrounding areas. The surface topography data may include surface roughness data, surface imaging data, location/positioning data, height sense data, angular orientation data, and any other such surface data.

The methods and processes described herein with regard to printing may also be used with other surface treatment equipment, such as, without limitation, cleaning, abrading, priming, protecting, repairing, or other such surface treatment applied along the contoured surface of the object to be treated.

The following is a non-exhaustive list of numbered examples, which may or may not be claimed, of the subject matter, disclosed herein.

The following portion of this paragraph delineates example 1 of the subject matter, disclosed herein. According to example 1, a method includes a step of preparing a surface of an aircraft part in a first processing booth to form a prepared surface of the aircraft part. Upon completion of preparing the surface, the method includes the step of transporting the aircraft part to a second processing booth, which is adjacent to the first processing booth. The method also includes a step of applying a livery to the prepared surface of the aircraft part in the second processing booth. Upon completion of applying the livery, the method includes the step of transporting the aircraft part to a third processing booth, which is adjacent to the second processing booth. The method also includes a step of applying a clearcoat over at least the livery applied to the prepared surface of the aircraft part in a third processing booth.

The following portion of this paragraph delineates example 2 of the subject matter, disclosed herein. According to example 2, which encompasses example 1, above, the method also includes a step of providing a reduced ambient light condition within the first processing booth, the second processing booth, and the third processing booth.

The following portion of this paragraph delineates example 3 of the subject matter, disclosed herein. According to example 3, which encompasses any one of examples 1 and 2, above, the first processing booth shares a common partition with the second processing booth and the step of transporting the aircraft part from the first processing booth to the second processing includes opening the common partition and transporting the aircraft part through the common partition.

The following portion of this paragraph delineates example 4 of the subject matter, disclosed herein. According to example 4, which encompasses any one of examples 1-3, above, the second processing booth shares a second common partition with the third processing booth and the step of transporting the aircraft part from the second processing booth to the third processing booth includes opening the second common partition and transporting the aircraft part through the second common partition.

The following portion of this paragraph delineates example 5 of the subject matter, disclosed herein. According to example 5, which encompasses any one of examples 1-4, above, the aircraft part comprises a wingless aircraft fuselage.

The following portion of this paragraph delineates example 6 of the subject matter, disclosed herein. According to example 6, which encompasses any one of examples 1-5, above, the step of applying the livery includes applying the livery using an inkjet system.

The following portion of this paragraph delineates example 7 of the subject matter, disclosed herein. According to example 7, which encompasses any one of examples 1-6, above, the aircraft part includes at least one aircraft wing, when separated from a corresponding aircraft fuselage.

The following portion of this paragraph delineates example 8 of the subject matter, disclosed herein. According to example 8, which encompasses any one of examples 1-7, above, the method includes before preparing the surface of the aircraft part in the first processing booth, removing paint from a portion of the surface of the aircraft part in a fourth processing booth and upon completion of removing paint from a portion of the surface of the aircraft part, transporting the aircraft part to the first processing booth being adjacent to the fourth processing booth.

The following portion of this paragraph delineates example 9 of the subject matter, disclosed herein. According to example 9, a system includes a first processing booth configured to enable preparation of a surface of an aircraft part, a second processing booth configured to enable application of a livery to at least a portion of the surface of the aircraft part, a first common partition disposed between the second processing booth and the first processing booth, a third processing booth configured to enable application of a clearcoat over at least a portion of the surface of the aircraft part, and a second common partition disposed between the second processing booth and the third processing booth.

The following portion of this paragraph delineates example 10 of the subject matter, disclosed herein. According to example 10, which encompasses example 9, above, the first processing booth, the second processing booth, and the third processing booth are configured to provide reduced ambient light conditions within respective booths.

The following portion of this paragraph delineates example 11 of the subject matter, disclosed herein. According to example 11, which encompasses example 9 or 10, above, the first common partition is configured to be placeable in at least a partially opened position and a closed position. When in the at least partially opened position, space of the first processing booth is exposed to space of the second processing booth.

The following portion of this paragraph delineates example 12 of the subject matter, disclosed herein. According to example 12, which encompasses any one of examples 9-11, above, the second common partition is configured to be placeable in at least a partially opened position and a closed position. When in the at least partially opened position, space of the second processing booth is exposed to space of the third processing booth.

The following portion of this paragraph delineates example 13 of the subject matter, disclosed herein. According to example 13, which encompasses any one of examples 9-12, above, the second processing booth comprises an inkjet system configured to apply the livery.

The following portion of this paragraph delineates example 14 of the subject matter, disclosed herein. According to example 14, which encompasses any one of examples 9-13, above, the aircraft part includes a wingless aircraft fuselage.

The following portion of this paragraph delineates example 15 of the subject matter, disclosed herein. According to example 15, which encompasses any one of examples 9-14, above, a fourth processing booth configured to allow for removal of paint from at least a portion of the surface of the aircraft part and a third common partition disposed between the third processing booth and the fourth processing booth.

The following portion of this paragraph delineates example 16 of the subject matter, disclosed herein. According to example 16, which encompasses example 15, above, the third common partition is configured to be placeable in at least a partially opened position and a closed position. When in the at least partially opened position, space of the second processing booth is exposed to space of the third processing booth.

The following portion of this paragraph delineates example 17 of the subject matter, disclosed herein. According to example 17, which encompasses any one of examples 9-16, above, the first processing booth, the second processing booth, and the third processing booth are configured to provide environmental conditions corresponding to what each is configured to enable.

The following portion of this paragraph delineates example 18 of the subject matter, disclosed herein. According to example 18, a hangar bay includes a surface processing structure that includes a first processing booth) configured to enable preparation of a surface of an aircraft part, a second processing booth configured to enable application of a livery to at least a portion of the surface of the aircraft part, a first common partition disposed between the second processing booth and the first processing booth, a third processing booth configured to enable application of a clearcoat over at least a portion of the surface of the aircraft part, and a second common partition disposed between the second processing booth and the third processing booth.

The following portion of this paragraph delineates example 19 of the subject matter, disclosed herein. According to example 19, which encompasses example 18, above, the surface processing structure further includes a fourth processing booth configured to allow for removal of paint from at least a portion of the surface of the aircraft part and a third common partition disposed between the fourth processing booth and the first processing booth.

The following portion of this paragraph delineates example 20 of the subject matter, disclosed herein. According to example 20, which encompasses any one of examples 18 and 19, above, the hangar bay further includes a transport system configured to seamlessly transport the aircraft part into the first processing booth, through the second processing booth and the third processing booth, and out of the third processing booth.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those skilled in the art will recognize that at least a portion of the controllers, devices, units, and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller/processor, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

For example, a central processing unit/processor or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A method comprising:
preparing a surface of an aircraft part in a first processing booth to form a prepared surface of the aircraft part;
upon completion of preparing the surface, transporting the aircraft part to a second processing booth being adjacent to the first processing booth;
applying a livery to the prepared surface of the aircraft part in the second processing booth;
upon completion of applying the livery, transporting the aircraft part to a third processing booth being adjacent to the second processing booth; and
applying a clearcoat over at least the livery applied to the prepared surface of the aircraft part in the third processing booth.

2. The method of claim 1, further comprising providing a reduced ambient light condition within the first processing booth, the second processing booth, and the third processing booth.

3. The method of claim 1, wherein:
the first processing booth shares a common partition with the second processing booth; and
transporting the aircraft part from the first processing booth to the second processing comprises:
opening the common partition; and
transporting the aircraft part through the common partition.

4. The method of claim 1, wherein:
the second processing booth shares a second common partition with the third processing booth; and
transporting the aircraft part from the second processing booth to the third processing booth comprises:
opening the second common partition; and
transporting the aircraft part through the second common partition.

5. The method of claim 1, wherein the aircraft part comprises a wingless aircraft fuselage.

6. The method of claim 1, wherein applying the livery comprises applying the livery using an inkjet system and applying ink as the print medium.

7. The method of claim 1, wherein the aircraft part comprises at least one aircraft wing, when separated from a corresponding aircraft fuselage.

8. The method of claim 1, further comprising:
before preparing the surface of the aircraft part in the first processing booth, removing paint and/or ink from a portion of the surface of the aircraft part in a fourth processing booth; and
upon completion of removing paint and/or ink from the portion of the surface of the aircraft part, transporting the aircraft part to the first processing booth being adjacent to the fourth processing booth.

9. A system comprising:
a first processing booth configured to enable preparation of a surface of an aircraft part;
a second processing booth configured to enable application of a livery to at least a portion of the surface of the aircraft part;
a first common partition disposed between the second processing booth and the first processing booth;
a third processing booth configured to enable application of a clearcoat over at least a portion of the surface of the aircraft part; and
a second common partition disposed between the second processing booth and the third processing booth.

10. The system of claim 9, wherein the first processing booth, the second processing booth, and the third processing booth are configured to provide reduced ambient light conditions within respective booths.

11. The system of claim 9, wherein the first common partition is configured to be placeable in at least a partially opened position and a closed position, when in the at least partially opened position, space of the first processing booth is exposed to space of the second processing booth.

12. The system of claim 9, wherein the second common partition is configured to be placeable in at least a partially opened position and a closed position, when in the at least partially opened position, space of the second processing booth is exposed to space of the third processing booth.

13. The system of claim 9, wherein the second processing booth comprises an inkjet system configured to apply the livery using ink as the print medium.

14. The system of claim 9, wherein the aircraft part comprises a wingless aircraft fuselage.

15. The system of claim 9, further comprising:
a fourth processing booth configured to allow for removal of paint and/or ink from at least a portion of the surface of the aircraft part; and
a third common partition disposed between the third processing booth and the fourth processing booth.

16. The system of claim 15, wherein the third common partition is configured to be placeable in at least a partially opened position and a closed position, when in the at least partially opened position, space of the second processing booth is exposed to space of the third processing booth.

17. The system of claim 9, wherein the first processing booth, the second processing booth, and the third processing booth are configured to provide environmental conditions corresponding to what each is configured to enable.

18. A hangar bay comprising:
a surface processing structure comprising:
a first processing booth configured to enable preparation of a surface of an aircraft part;
a second processing booth configured to enable application of a livery to at least a portion of the surface of the aircraft part;
a first common partition disposed between the second processing booth and the first processing booth;
a third processing booth configured to enable application of a clearcoat over at least a portion of the surface of the aircraft part; and
a second common partition disposed between the second processing booth and the third processing booth.

19. The hangar bay of claim 18, wherein the surface processing structure further comprises:
a fourth processing booth configured to allow for removal of paint and/or ink from at least a portion of the surface of the aircraft part; and
a third common partition disposed between the fourth processing booth and the first processing booth.

20. The hangar bay of claim 18, further comprising a transport system configured to seamlessly transport the aircraft part into the first processing booth, through the second processing booth and the third processing booth, and out of the third processing booth.
